(19) United States
(12) Patent Application Publication
(10) Pub. No.: US 2010/0287535 A1
(43) Pub. Date: Nov. 11, 2010

(54) SYSTEM AND METHOD FOR TESTING SOFTWARE RELIABILITY USING FAULT INJECTION

(75) Inventors: YOUNG HO KIM, Daejeon (KR); GYU IL CHA, Daejeon (KR); SUNG IN JUNG, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejeon (KR)

(21) Appl. No.: 12/560,070

(22) Filed: Sep. 15, 2009

(30) Foreign Application Priority Data
May 8, 2009 (KR) 10-2009-0040284

(51) Int. Cl. G06F 11/36

(52) U.S. Cl. 717/127

(57) ABSTRACT

A software reliability test system is provided. The software reliability test system includes a fault injection system and a workload generation system. The fault injection system creates a fault injection delegate to inject a fault into software selected as a test target from software of a target system. The workload generation system generates a workload in the selected software according to a control of the fault injection system to allow the fault injection delegate to inject the fault into the selected software.

### CROSS-REFERENCE TO RELATED APPLICATIONS

This application claims priority under 35 U.S.C. §119 to Korean Patent Application No. 10-2009-40284, filed on May 8, 2009, in the Korean Intellectual Property Office, the disclosure of which is incorporated herein by reference in its entirety.

### TECHNICAL FIELD

The following disclosure relates to a system and a method for testing software reliability using fault injection, and in particular, to a system and a method for testing software reliability through workload generation in consideration of target software characteristics, by creating a fault injection delegate to inject a fault into target software, loading the fault injection delegate to a target system, and injecting the fault into the target software.

### BACKGROUND

Software reliability test methods using fault injection and workload generation are used for development of various device drivers and executable codes that are dynamically loaded. Also, the methods have been widely used in availability tests for systems, and for fault-tolerant system benchmarking.

Software Fault injection methods can be categorized by compile-time injection methods and runtime injection methods.

The compile-time fault injection method injects errors into the source code or assembly code of the target program. To inject faults, the program instruction must be modified before the program image is loaded and executed. The modified code alters the target program instructions, causing injection.

The runtime fault injection method is divided into a method of modifying a specific memory region or a value of a register, and a method of injecting a fault by dynamically inserting a code into a binary image of an executed program.

The compile-time fault injection method using source modification enables fault injection into a region that a user desires. However, modification and recompiling of a source are required. Also, it is inconvenient to repeatedly perform the same job to inject a fault into other software of a target system. This method requires the modification of the program that will evaluate fault effect, and it requires no additional software during runtime. Because the fault effect is hard-coded, develops can use it to emulate permanent faults.

The runtime fault injection method that modifies a memory region or a value of a register enables a free fault injection without a modification or a recompilation of a target source code. However, it is difficult to know which part of a test target a fault is injected into. That is, the runtime fault injection method is appropriate when testing the entire software of a test target, but not when testing specific software that a user wants to test. In a fault injection method that uses dynamic code insertion, a dynamic fault injection is possible during the execution of target software. However, since designation of a fault injection location and a fault value is required, complexity such as understanding of a source increases.

These related-art software reliability test methods have a limitation in that a software reliability test is difficult to perform because a fault is not injected into specific software of a target system, but is injected into a total target system. Fault injection methods with respect to software require complex processes such as recompilation by code modification, or designation of fault injection locations through understanding software flow. Furthermore, in regard to workload generation for activation of an injected fault, it is difficult to generate a concentrated workload considering the operating characteristics of target software.

### SUMMARY

In one general aspect, a software reliability test system includes: a fault injection system creating a fault injection delegate to inject a fault into software selected as a test target from a target system; and a workload generation system generating a workload in the selected software according to a control of the fault injection system to cause the injected fault.

In another general aspect, a software reliability test method includes: selecting and extracting information from target software running on the target system to test; creating a fault injection delegate injecting a fault into the selected software; and generating a workload in the selected software to cause the injected fault.

Other features and aspects will be apparent from the following detailed description, the drawings, and the claims.

### BRIEF DESCRIPTION OF THE DRAWINGS

FIG. 1 is a diagram illustrating a software reliability test system according to an exemplary embodiment.

FIG. 2 is a diagram illustrating an exemplary fault injection system of FIG. 1.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

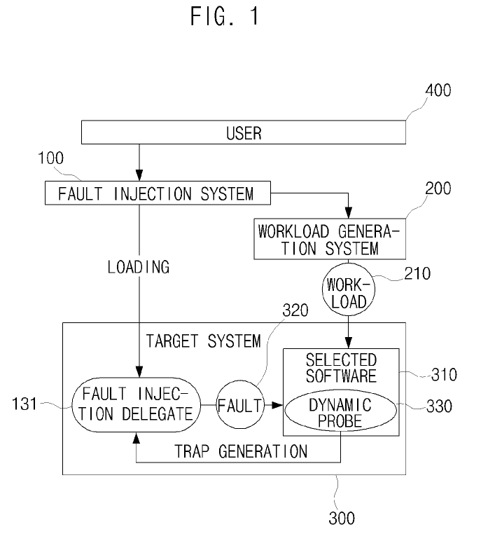

A software reliability test system according to an exemplary embodiment will be described with reference to FIG. 1. FIG. 1 is a diagram illustrating a software reliability test system according to an exemplary embodiment.

Referring to FIG. 1, a software reliability test system includes a fault injection system 100 and a workload generation system 200.

The fault injection system 100 receives information from a user 400, creates a fault injection delegate 131 using the information, and loads the fault injection delegate 131 to a target system 300.

The fault injection delegate 131 loaded to the target system 300 injects a fault 320 into software 310 selected from the target system by a user.

The fault injection system 100 controls the workload generation system 200 to cause the injected fault 320.

The workload generation system 200 generates a workload 210 suitable for the selected software 310 according to the control of the fault injection system 100.

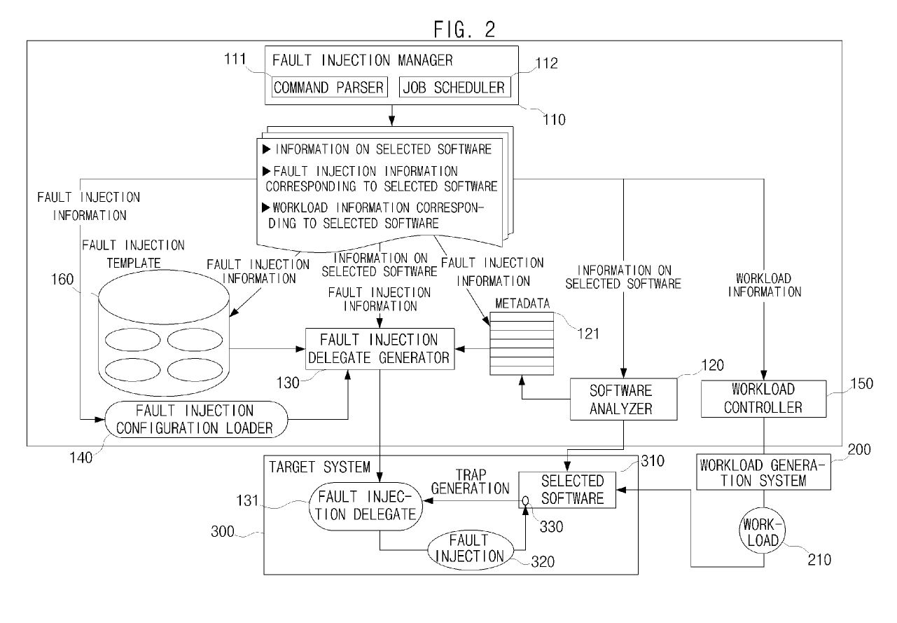

Hereinafter, a configuration the fault injection system in FIG. 1 and a method of operating the software reliability test system will be more fully described. FIG. 2 is a diagram illustrating the fault injection system of FIG. 1.

Referring to FIG. 2, a fault injection system 100 includes a fault injection manager 110, a software analyzer 120, a fault injection delegate generator 130, a fault injection delegate 131, a fault injection configuration loader 140, and a workload controller 150.

The fault injection manager 110 includes a command parser 111 and a job scheduler 112.

The command parser 111 provides a command tool interface to a user, and interprets a command that the user inputs. Then, the command parser 111 parses the interpreted command into information of the software 310, fault injection information of the selected software 310, and workload information of the selected software 310.

The command parser 111 delivers the parsed information to the software analyzer 120, the fault injection delegate generator 130, the fault injection configuration loader 140, and the workload controller 150, respectively.

Here, information of the selected software 310 indicates which software is selected as a target from a plurality of softwares that may be loaded and operated in the target system 300 as occasion demands. When software A is selected, information on the selected software indicates that the software A is selected as a test target, fault injection information includes a fault type of the selected software 310, a fault injection period, a fault injection interval, a fault injection maximum frequency, and a time limit of an operation of the fault injection delegate 131, and workload information includes a workload generation program (for example, a workload generation program that generates an appropriate workload for software 310 selected from a plurality of workload generation programs included in the workload generation system 200) generating a workload during a normal operation other than a test operation, and an option necessary for running the workload generation program.

The job scheduler 112 controls the operations of the software analyzer 120, the fault injection delegate generator 130, the fault injection configuration loader 140, and the workload controller 150 according to a preset job sequence of a software reliability test.

The preset job sequence may be set to an analysis of the software 310 that is selected as a test target, a generation of the fault injection delegate 131, a fault injection information configuration to the fault injection delegate 131, a fault injection into the selected software 310, a workload generation control in the selected software 310, and a completion of the software reliability test.

The analysis of the software 310 that is selected as a test target may be performed by the software analyzer 120. The generation of the fault injection delegate 131 may be performed by the fault injection delegate generator 130. The fault injection information configuration to the fault injection delegate 131 may be performed by the fault injection information configuration loader 140. The fault injection into the selected software 310 may be performed by the fault injection delegate 131. The workload generation control in the selected software 310 may be performed by the workload controller 150. The completion of the software reliability test may be performed by the job scheduler 112.

The job scheduler 112 controls the operations of the software analyzer 120, the fault injection delegate generator 130, the fault injection configuration loader 140, the fault injection delegate 131 and the workload controller 150 to allow each job to be performed according to the job sequence. That is, the job scheduler 112 determines a next job sequence according to a result of an ongoing job, and controls the operations of the software analyzer 120, the fault injection delegate generator 130, the fault injection configuration loader 140, the fault injection delegate 131, and the workload controller 150 to allow the next job to be performed according to the determined job sequence.

For example, if the command parser 111 parses a command received from a user to deliver necessary information to the software analyzer 120, the fault injection delegate generator 130, the fault injection configuration loader 140, and the workload controller 150, the job scheduler 112 controls the software analyzer 120 so that the analysis of the selected software 310 may be performed according to the pre-determined job sequence.

The job scheduler 112 receives and verifies a result of the analysis of the selected software 310 from the software analyzer 120. If the result is normal, a generation of the fault injection delegate 131 may be determined as a next job. The job scheduler 112 may control the fault injection delegate generator 130 using the information delivered from the command parser 111 so that the generation of the fault injection delegate 131 may be performed according to the determined job sequence.

However, if the result is abnormal, the job scheduler 112 determines the next job as a test end. It performs a appropriate error processing, and then finish the software reliability test.

The job scheduler 112 may control the next job processing by verifying not only a pre-determined job sequence of the software reliability test but also a time duration which the fault injection delegate 131 can be executed on the target system 300.

For example, if the execution time of the fault injection delegate 131 exceeds a limited time, the job scheduler 112 may finish the fault injection delegate 131 and the workload generation program to end software reliability test.

The software analyzer 120 analyzes the selected software 310 using the information delivered from the command parser 111 to extract metadata. The extracted metadata may include functions of the selected software 310 and the addresses of the functions.

The fault injection delegate generator 130 is loaded to the target system 300 to create the fault injection delegate 131 that performs the fault injection 320 on the selected software 310.

For example, the fault injection delegate generator 130 determine a fault injection location using the metadata extracted from the software analyzer 120 and the fault type, and create the fault injection delegate 131 using the determined fault injection location, the information on the selected software 310, the fault injection information, and a fault injection template 160. Here, the fault injection template 160 may be a library-type template in which a routine performing a fault injection 320 for the type of a fault to be injected into the selected software 310 is defined.

More concretely, if explaining the generation of the fault injection delegate 131, the fault injection delegate generator 130 may determine the fault injection location of the selected software 310 using the extracted metadata and the fault type. The fault injection delegate generator 130 may create a fault injection routine according to the selected fault type using the determined fault injection location and the fault injection template 160. After creating the fault injection routine, the fault injection delegate generator 130 may create a fault injection delegate 131 reflecting a fault injection period, the fault injection interval, the fault injection maximum frequency, and the created fault injection routine using the fault injection information.

On the other hand, the fault injection system 100 may further include a dynamic probe 330 generating a trap at the fault injection location of the software 310. When the generation of the fault injection delegate 131 is completed, the dynamic probe 330 may be inserted into a function corresponding to the fault injection location of the selected software 310 using the fault injection information and the extracted metadata.

The created fault injection delegate 131 is loaded to the target system 300, and is in a fault injection idle state until a dynamic probe 330 of the selected software 310 is driven to generate a trap. If a trap is generated, the fault injection delegate 131 is switched to a fault injection active state.

The fault injection configuration loader 140 sets a fault injection period, a fault injection interval, and fault injection maximum frequency for the fault injection delegate 131. The fault injection delegate 131 may perform the fault injection 320 into the selected software 310 using the fault injection period, the fault injection interval, and the fault injection maximum frequency according to the fault injection routine.

For example, when a fault injection location of the selected software 310 is called after the fault injection delegate 131 is loaded to the target system 300, and the dynamic probe 330 is inserted into a binary image (for example, a fault injection location of the selected software 310) of the target software, the dynamic probe 330 generates a trap to allow the fault injection delegate 131 to perform a fault injection routine.

The workload controller 150 receives information on a workload generation program suitable for the characteristics of the selected software 310, and option information necessary for execution of the workload generation program from the command parser 111, and controls a workload generation of the workload generation system 200 so that the injected fault may be activated.

As described above, the operation of the software reliability test system has been described. Hereinafter, an operation flow between the fault injection delegate 131 and the software 310 through the dynamic probe 330, and an operation method of the fault injection delegate 131 that injects a fault into the selected software 310 will be fully described.

If, during operation of the selected software 310, a function corresponding to a fault injection location is called, and a trap is generated by a dynamic probe 330 inserted into a binary image of the selected software 310, then a control is transferred to the fault injection delegate 131 that performs a fault injection operation using fault injection routines corresponding to the fault type.

For example, the fault injection delegate 131 that has received the control checks a fault injection period, a fault injection interval, and a fault injection maximum frequency according to the fault injection routine. If a check result corresponds to a fault injection condition, a fault is injected into the fault injection location of the selected software 310.

The fault injection delegate 131 that has completed the fault injection transfers the control to the selected software 310, which resumes an operation after the fault injection location.

The fault injection delegate 131 may perform a fault injection whenever a trap is generated by the dynamic probe 330 until operation time in the target system is up.

A fault can be injected into a fault injection location of the selected software 310 through the dynamic probe 330 and the created fault injection delegate 131 according to a fault injection period, a fault injection interval, a fault injection maximum frequency that are designated by a user. Accordingly, an efficient reliability test on the selected software 310 can be conducted without modification, recompiling, and re-running of a source code.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different method and/or replaced or supplemented by other components or their equivalents. Accordingly, other implementations are within the scope of the following claims.

What is claimed is:

1. A software reliability test system comprising:
a fault injection system creating a fault injection delegate to inject a fault into software selected as a test target from a target system; and
a workload generation system generating a workload in the selected software according to a control of the fault injection system to cause the injected fault.

2. The software reliability test system of claim 1, wherein the fault injection system creates the fault injection delegate by receiving fault injection information comprising at least one of a fault type of the selected software, a fault injection period, a fault injection interval, a fault injection maximum frequency, and an operation time limit of the fault injection delegate in the target system, and information on the selected software.

3. The software reliability test system of claim 2, wherein the fault injection system dynamically loads the fault injection delegate to the target system, checks an operation duration of the fault injection delegate in the target system, and finishes the fault injection delegate if the operation duration exceeds the operation time limit.

4. The software reliability test system of claim 1, wherein the fault injection system comprises:
a fault injection manager receiving fault injection information comprising at least one of a fault type of the selected software, a fault injection period, a fault injection interval, a fault injection maximum frequency, and an operation time limit of the fault injection delegate in the target system, information on the selected software, and workload information for generating a workload in the selected software;
a software analyzer extracting metadata by analyzing the selected software; and
a fault delegate generator determining a fault injection location using the extracted metadata and the fault type, and creating the fault injection delegate using the fault injection location, the fault injection information, and a fault injection template of a library type comprising a fault injection routine for the fault type.

5. The software reliability test system of claim 4, wherein the fault injection system further comprises a fault injection configuration loader configuring the fault injection period, the fault injection interval, and the fault injection maximum frequency for the created fault injection delegate.

6. The software reliability test system of claim 4, wherein the fault injection manager comprises:
a command parser providing a user with an interface, and interpreting a command inputted by the user to parse into the information on the selected software, the fault injection information, and the workload information; and
a job scheduler checking an operation duration of the fault injection delegate in the target system, and finishing the fault injection delegate if the operation duration exceeds the operation time limit.

7. The software reliability test system of claim 4, further comprising a workload controller controlling the workload generation system using the workload generation information to activate the injected fault.

8. The software reliability test system of claim 4, wherein the fault injection system further comprises a dynamic probe generating a trap at the fault injection location of the selected software.

9. The software reliability test system of claim 8, wherein the fault injection system inserts the dynamic probe into a function corresponding to the fault injection location of the selected software using the fault injection information and the extracted metadata, and
injects the fault into the fault injection location according to the fault injection routine corresponding to the fault type if the trap is generated in the function corresponding to the fault injection location by the inserted dynamic probe.

10. A software reliability test method comprising:
selecting software from softwares of a target system to test;
creating a fault injection delegate injecting a fault into the selected software; and
generating a workload in the selected software to activate the injected fault.

11. The software reliability test method of claim 10, wherein the selecting of software comprises receiving fault injection information comprising at least one of a fault type of the selected software, a fault injection period, a fault injection interval, a fault injection maximum frequency, and an operation time limit of the fault injection delegate in the target system, information on the selected software, and workload information for generating a workload in the selected software.

12. The software reliability test method of claim 11, wherein the creating of a fault injection delegate comprises extracting metadata by analyzing the selected software; and
determining a fault injection location using the extracted metadata and the fault type, and
the creating of a fault injection delegate is based on the fault injection location, the fault injection information, and a fault injection template of a library type comprising a fault injection routine for fault type.

13. The software reliability test method of claim 12, wherein the creating of a fault injection delegate further comprises:
configuring the fault injection period, the fault injection interval, and the fault injection maximum frequency for the created fault injection delegate; and
dynamically loading the configured fault injection delegate to the target system.

14. The software reliability test method of claim 13, wherein the dynamic loading of the configured fault injection delegate comprises:
inserting a dynamic probe generating a trap into the determined fault injection location; and
injecting a fault into the fault injection location according the fault injection routine when the fault injection location is called to generate the trap.

15. The software reliability test method of claim 13, wherein the dynamic loading of the configured fault injection delegate comprises:
checking an operation duration of the fault injection delegate in the target system; and
finishing the fault injection delegate when the operation duration exceeds the operation time limit.

16. The software reliability test method of claim 11, wherein the generating of a workload comprises:
allowing the created fault injection delegate to inject the fault into the selected software; and
generating a workload using workload generation information corresponding to the selected software to cause the injected fault.
